(19) United States
(12) Patent Application Publication
(10) Pub. No.: US 2026/0017128 A1
(43) Pub. Date: Jan. 15, 2026

(54) TELEMETRY DATA COLLECTION SYSTEM AND TELEMETRY DATA COLLECTION METHOD

(71) Applicant: Hitachi, Ltd., Tokyo (JP)

(72) Inventors: Hitoshi YABUSAKI, Tokyo (JP); Takahiro SAGARA, Tokyo (JP)

(73) Assignee: Hitachi, Ltd., Tokyo (JP)

(21) Appl. No.: 19/254,469

(22) Filed: Jun. 30, 2025

(30) Foreign Application Priority Data
Jul. 11, 2024 (JP) 2024-111996

(51) Int. Cl. G06F 11/07

(52) U.S. Cl. CPC G06F 11/0778; G06F 11/0709

(57) ABSTRACT

Provided is a technique that enables collecting effective telemetry data from a distributed system. Monitoring agents record acquired telemetry data in a buffer and transmit telemetry data satisfying a predetermined condition to a monitoring manager, the monitoring manager identifies a perpetuation condition indicating a monitoring agent to perform perpetuation, and a data range to be perpetuated, and a transmission condition indicating a monitoring agent from which telemetry data is to be additionally collected, and telemetry data to be additionally collected, based on the received telemetry data, the monitoring manager notifies the perpetuation monitoring agent of the perpetuation condition, the monitoring agent perpetuates the perpetual data range according to the notified perpetuation condition, the monitoring manager notifies the additional transmission monitoring agent of the transmission condition, and the additional transmission monitoring agent transmits the additional transmission telemetry data in the buffer to the monitoring manager according to the notified transmission condition.

### TECHNICAL FIELD

The present disclosure relates to techniques for collecting telemetry data from systems.

### BACKGROUND ART

In recent years, there has been a growing market for log management for acquiring telemetry data from applications in various systems, recording the telemetry data as logs, and managing the telemetry data. In general, collection of telemetry data consumes resources of a system to be subjected to the telemetry data collection (referred to as a “target system”, hereinafter). Therefore, in order to prevent deterioration of the performance of the target system and an increase of the cost required for operating the target system, telemetry data to be acquired is limited in many cases. For example, for a system which is not allowed to have its performance influenced, such as a financial system, telemetry data acquired therefrom is limited to a minimum, in order to suppress the influence on its performance. Therefore, in the event of rare occurrence of an error, there may be difficulty in investigating the cause of the error through an analysis of the limited telemetry data.

Patent Literature 1 discloses a technique that enables analyzing errors while limiting logs to be outputted. In the technique of Patent Literature 1, in an application in a target system, logs are classified into plural levels, and the log levels of logs to be outputted are limited in a normal state, while detailed logs are buffered interiorly. In the event of occurrence of an error, such as a transaction failure, a detailed log is outputted from the buffer retroactively to the time of the occurrence of the error. There, the amount of data of logs outputted in the normal state is limited to a small amount, and in the event of occurrence of an error, it is possible to perform analyses using the buffered logs. Furthermore, in the event of occurrence of an error, it is necessary to output only logs recorded in the buffer about several tens to several hundreds of milliseconds before in the process which has induced the error. This can reduce the resources of the system required to output logs to a certain extent.

### CITATION LIST

### Patent Literature

Patent Literature 1: U.S. Pat. No. 9,891,979B2

### SUMMARY OF INVENTION

### Technical Problem

There have been increasingly services using microservices for causing a plurality of hosts to perform processes cooperatively with each other. An application constructed using the microservice is constituted by a plurality of sub applications disposed on a plurality of hosts. In a case where a distributed system such as a microservice is a target system, telemetry data acquired in processes of a plurality of sub applications may be required in order to analyze the cause of an error. However, the technique of Patent Literature 1 gives no consideration to acquiring telemetry data over a plurality of processes in a distributed system. Further, the technique of Patent Literature 1 gives no consideration to the possibility that resources are influenced by acquisition of telemetry data from plural processes.

It is an object of the present disclosure to provide a technology that enables collecting effective telemetry data from a distributed system.

### Solution to Problem

A telemetry data collection system for collecting telemetry data in an application constituted by a plurality of sub applications, the telemetry data collection system including: monitoring agents adapted to acquire telemetry data from a process of the sub applications; and a monitoring manager adapted to receive telemetry data from the monitoring agents; wherein the monitoring agents record the acquired telemetry data in a buffer and transmit telemetry data satisfying a predetermined condition, out of the acquired telemetry data, to the monitoring manager, the monitoring manager identifies a perpetuation condition indicating a perpetuation monitoring agent as a monitoring agent to perpetuate telemetry data recorded in the buffer, and a perpetual data range indicating a data range to be perpetuated out of the telemetry data recorded in the buffer, and a transmission condition indicating an additional transmission monitoring agent as monitoring agent from which telemetry data is to be additionally collected, and additional transmission telemetry data as telemetry data to be additionally collected, based on the telemetry data received from the monitoring agents, the monitoring manager notifies the perpetuation monitoring agent of the perpetuation condition, the perpetuation monitoring agent perpetuates the perpetual data range according to the notified perpetuation condition, the monitoring manager notifies the additional transmission monitoring agent of the transmission condition, and the additional transmission monitoring agent transmits the additional transmission telemetry data in the buffer to the monitoring manager according to the notified transmission condition.

### Advantageous Effects of Invention

In one aspect of the present disclosure, it is possible to collect effective telemetry data from a distributed system.

### BRIEF DESCRIPTION OF DRAWINGS

FIG. 1 is an overall block diagram including a telemetry data collection system and a target system.

FIG. 2 is a sequence diagram illustrating a data collection sequence.

FIG. 3 is a sequence diagram of a perpetual data identification sequence.

FIG. 4 is a sequence diagram of a sequential data extraction sequence.

FIG. 5 is a block diagram of a monitoring manager.

FIG. 6 is a view illustrating an example of a buffer flush condition table.

FIG. 7 is a view illustrating an example of a screen for setting a buffer flush condition.

FIG. 8 is a view illustrating an example of a sub-application agent mapping table.

FIG. 9 is a view illustrating an example of a sub-application logical structure table.

FIG. 10 is a diagram illustrating an example of a buffer size table.

FIG. 11 is a diagram illustrating an example of a related telemetry table.

FIG. 12 is a flowchart of a perpetual data identification process.

FIG. 13 is a flowchart of a sequential data extraction process.

FIG. 14 is a flowchart of a buffer-size/transmission-rate calculation process.

### DESCRIPTION OF EMBODIMENTS

Hereinafter, an embodiment of the present invention will be described with reference to the drawings.

In the drawings, components having the same function are denoted by the same reference sign, and will not be described redundantly. Further, in order to distinguish individual components having the same function, each of these components may be provided with a reference sign constituted by a main reference sign assigned to the components having the same function, and a sub reference sign added thereto after a hyphen for distinguishing the individual components. Further, even a component provided with such a reference sign constituted by a main reference sign and a sub reference sign may be described by being provided with only the main reference sign, in a case where there is no need for distinguishing the individual components or in a case where the individual components cannot be distinguished.

The telemetry data collection system according to the present embodiment is a system for collecting telemetry data from applications in a target system constituted by a plurality of sub-application containers disposed on a plurality of host computers (which will be also referred to as “hosts”, hereinafter).

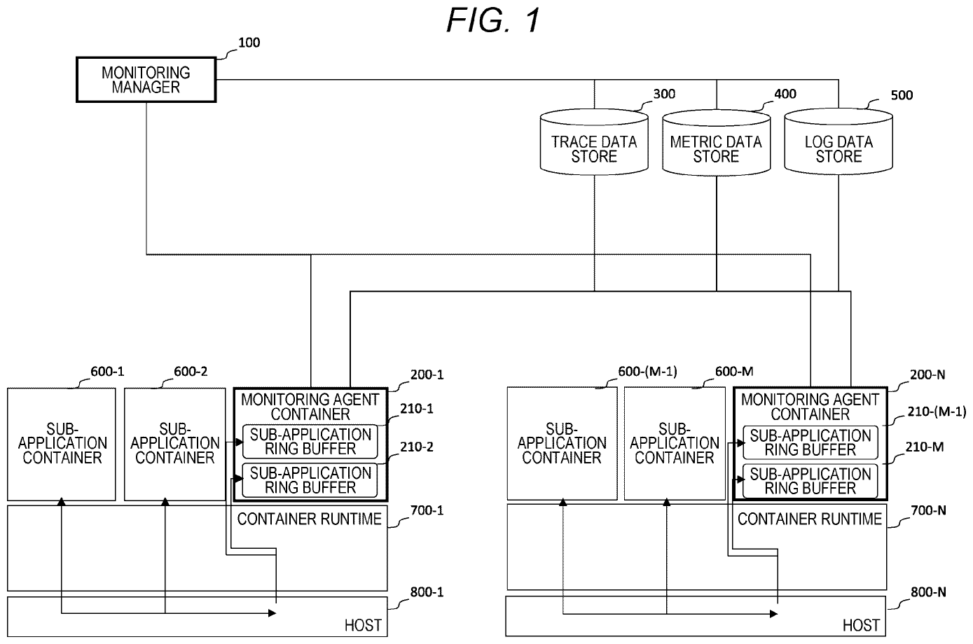

FIG. 1 is an overall block diagram including a telemetry data collection system and a target system.

The target system is a system from which telemetry data is to be collected, and is a distributed system including a plurality of hosts 800-1 to 800-N. In the host 800-1, there are constructed a plurality of sub-application containers 600-1 to 600-2 and a monitoring agent container 200-1, which are driven by a container runtime 700-1. In the host 800-N, there are constructed sub-application containers 600-(M−1) to 600-M and a monitoring agent container 200-N, which are driven by a container runtime 700-N. The sub-application containers 600-1 to 600-M constitute applications in the target system.

Further, the telemetry data collection system includes a monitoring manager 100, and a plurality of monitoring agent containers 200-1 to 200-N.

The monitoring agent container 200-1 is a container that acquires telemetry data from processes in the sub-application containers 600-1 to 600-2 on the host 800-1. The monitoring agent container 200-N is a container that acquires telemetry data from processes in the sub-application containers 600-(M−1) to 600-M on the host 800-N.

The monitoring agent container 200-1 includes sub-application ring buffers 210-1 to 210-2 corresponding to the respective sub-application containers 600-1 to 600-2. The monitoring agent container 200-N includes sub-application ring buffers 210-(M−1) to 210-M corresponding to the respective sub-application containers 600-(M−1) to 600-M.

The monitoring manager 100 is a computer that receives telemetry data, while controlling transmission of telemetry data from the monitoring agent containers 200-1 to 200-N.

The monitoring manager 100 and the monitoring agent containers 200 operate in cooperation with each other, as follows.

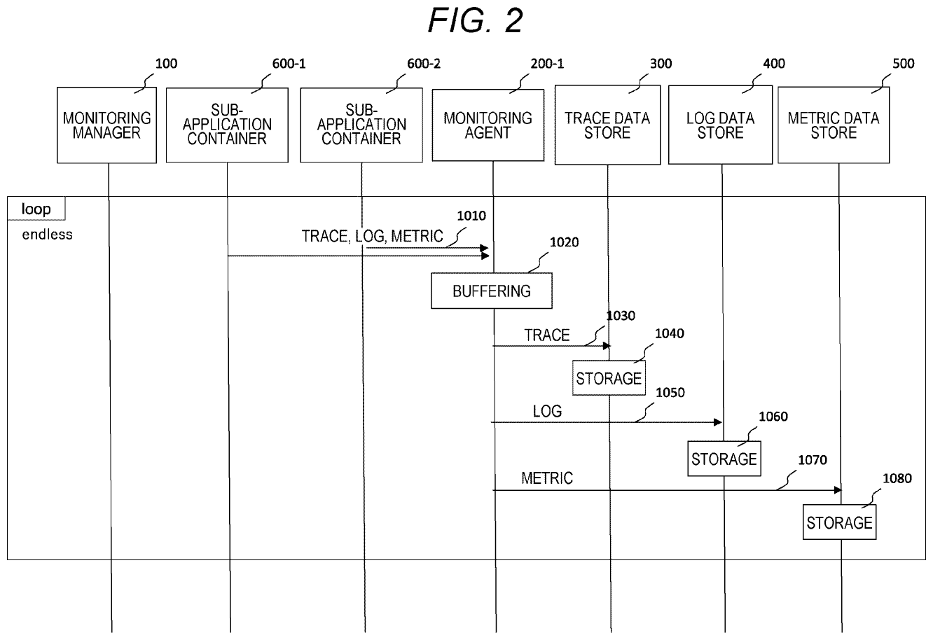

FIG. 2 is a sequence diagram illustrating a data collection sequence. The data collection sequence is a sequence for causing the telemetry data collection system to collect telemetry data from the target system, in a normal state.

Referring to FIG. 2, at first, telemetry data in each sub-application container 600-1, 600-2 is acquired in the monitoring agent container 200-1 (step 1010). The telemetry data includes trace data, log data, and metric data. The trace data is data obtained by sampling data in a memory in the container at predetermined timing. The metric data is data indicating an index value calculated based on the operation of the container. The log data is data that records the operation of the container.

The monitoring agent container 200-1 records the telemetry data in the sub-application ring buffers 210-1 and 210-2 (step 1020).

Further, the monitoring agent container 200-1 transmits trace data satisfying a predetermined condition, among the telemetry data, to a trace data store 300 (step 1030). The trace data is stored in the trace data store 300 (step 1040).

Further, the monitoring agent container 200-1 transmits log data satisfying a predetermined condition to a log data store 500 (step 1050). The log data is stored in the log data store 500 (step 1060).

Further, the monitoring agent container 200-1 transmits metric data satisfying a predetermined condition to a metric data store 400 (step 1070). The metric data is stored in the metric data store 400 (Step 1080).

Consequently, the monitoring agent container 200-1 records, in the respective sub-application ring buffers 210-1 to 210-2, the telemetry data acquired from the processes in the sub-application containers 600-1 and 600-2, and transmits only telemetry data corresponding to the predetermined conditions, out of the telemetry data, to the data stores under the management of the monitoring manager 100.

Similarly, the other monitoring agent containers 200 also record, in the respective sub-application ring buffers 210, telemetry data acquired from the processes in the sub-application containers 600, and transmit only telemetry data corresponding to predetermined conditions to the data stores under the management of the monitoring manager 100.

The processes in the steps 1010 to 1080 are periodically and repeatedly executed.

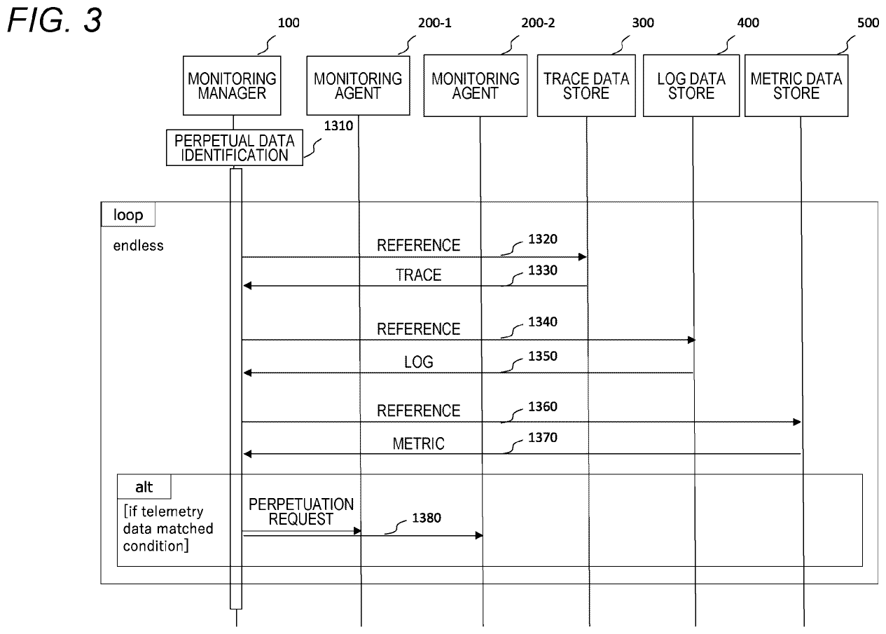

FIG. 3 is a sequence diagram of a perpetual data identification sequence.

The perpetual data identification sequence is a sequence, as follows. That is, when telemetry data stored in a sub-application ring buffer 210 in a monitoring agent container 200 is required to be transmitted to the monitoring manager 100, the perpetual data identification sequence identifies a data range to be perpetuated and requests the monitoring agent container 200 to perpetuate the data region. Hereinafter, transmitting telemetry data stored in the sub-application ring buffers 210 to the monitoring manager 100 will be referred to as buffer flushing, in some cases.

Further, here, the term “perpetuating” means bringing desired data in the buffer into a state of being prevented from being lost. In the present embodiment, since the ring buffers are used as an example, overwriting in areas storing data to be perpetuated in the ring buffers is prohibited. As another example, in a case of using buffering that provides a storage time limit by time-to-live (TTL), it is possible to perpetuate data by erasing the storage time limits of areas storing data to be perpetuated.

Referring to FIG. 3, if the monitoring manager 100 starts a process for identifying perpetual data (step 1310), the monitoring manager 100 refers to the trace data stored in the trace data store 300 at first (step 1320) and acquires the trace data (step 1330).

Further, the monitoring manager 100 refers to the log data stored in the log data store 500 (step 1340) and acquires the log data (step 1350). Further, the monitoring manager 100 refers to the metric data stored in the metric data store 400 (step 1360) and acquires the metric data (step 1370).

Then, if the monitoring manager 100 determines that buffer flushing is necessary based on the telemetry data from all the monitoring agent containers 200, the monitoring manager 100 identifies a perpetuation condition indicating a monitoring agent container (perpetuation monitoring agent) to perpetuate telemetry data recorded in a sub-application ring buffer 210, and a perpetual data range indicating a data range to be perpetuated among the telemetry data recorded in the sub-application ring buffer 210, and a transmission condition indicating a monitoring agent container (additional transmission monitoring agent) from which telemetry data is to be additionally collected, and additional transmission telemetry data as telemetry data to be additionally collected. At this time, as an example, the monitoring manager 100 determines that buffer flushing is necessary, if the telemetry data referred to satisfies a predetermined condition. Hereinafter, this condition will be referred to as a buffer flush condition, in some cases.

Then, the monitoring manager 100 transmits a perpetuation request including the identified perpetuation condition to the monitoring agent container 200 that has become the perpetuation monitoring agent, among the monitoring agent containers 200-1 to 200-N (step 1380). The monitoring agent container 200 having received the notification perpetuates the perpetual data range, in accordance with the notified perpetuation condition.

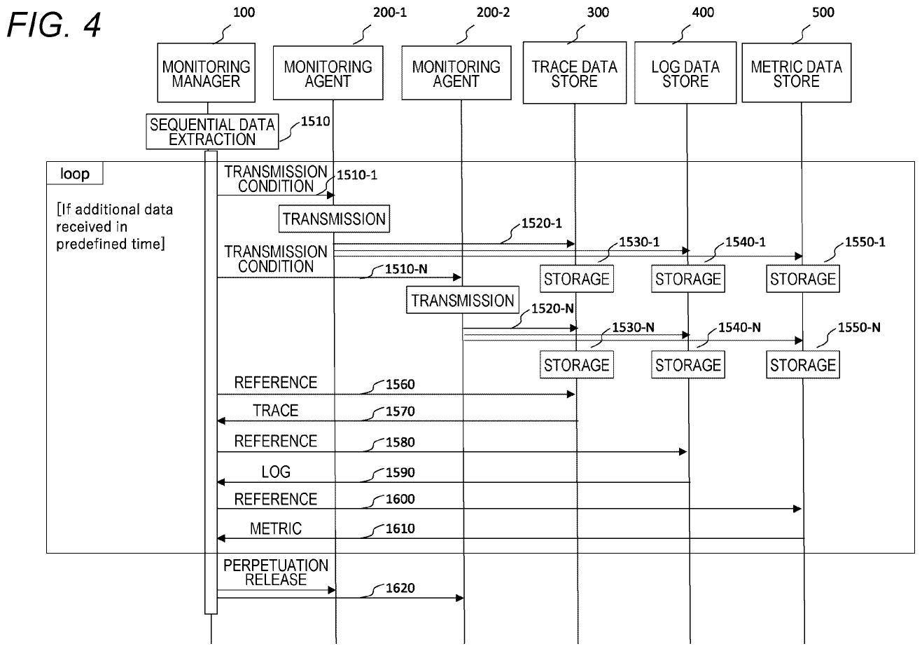

FIG. 4 is a sequence diagram of a sequential data extraction sequence. The sequential data extraction sequence is a sequence for sequentially selecting necessary data from the data perpetuated in a sub-application ring buffer 210 and, further, performing buffer flushing thereon.

Referring to FIG. 4, if the monitoring manager 100 starts a process for sequential data extraction (step 1510), at first, the monitoring manager 100 provides a notification of the transmission condition, to the monitoring agent containers 200 having become additional transmission monitoring agents according to the transmission condition, out of the monitoring agent containers to 200-1 to 200-N (steps 1510-1 and 1510-N). In FIG. 4, it is assumed that the monitoring agent containers 200-1 and 200-N have become the additional transmission monitoring agents.

On receiving the notification, the additional transmission monitoring agents transmit additional transmission telemetry data in sub-application ring buffers 210 to the monitoring manager 100, according to the notified transmission condition (steps 1520-1 and 1520-N).

Out of the additional transmission telemetry data, the trace data is stored in the trace data store 300 (steps 1530-1 and 1530-N). The log data is stored in the log data store 500 (steps 1540-1 and 1540-N). Further, the metric data is stored in the metric data store 400 (steps 1550-1 and 1550-N).

Thereafter, the monitoring manager 100 refers to the trace data stored in the trace data store 300 (step 1560) and acquires the trace data (step 1570). Further, the monitoring manager 100 refers to the log data stored in the log data store 500 (step 1580) and acquires the log data (step 1590). Further, the monitoring manager 100 refers to the metric data stored in the metric data store 400 (step 1600) and acquires the metric data (step 1610).

Then, based on the acquired telemetry data, the monitoring manager 100 further identifies a transmission condition indicating a monitoring agent container (additional transmission monitoring agent) from which telemetry data is to be further additionally collected, and additional transmission telemetry data as telemetry data to be additionally collected.

If there is telemetry data to be further additionally collected, the monitoring manager 100 transmits the transmission condition to the additional transmission monitoring agent and repeats the process. If there is no telemetry data to be further additionally collected, the monitoring manager 100 transmits a request for releasing the perpetuation to the monitoring agent containers 200 (step 1620). On receiving the request, the monitoring agent container 200 releases the perpetuation of the perpetuated data range.

As described above, according to the telemetry data collection system according to the present embodiment, the monitoring manager 100 controls perpetuation and transmission of telemetry data buffered in the monitoring agent containers 200 based on telemetry data received from the monitoring agent containers 200, which enables collecting effective telemetry data from the target system, which is a distributed system.

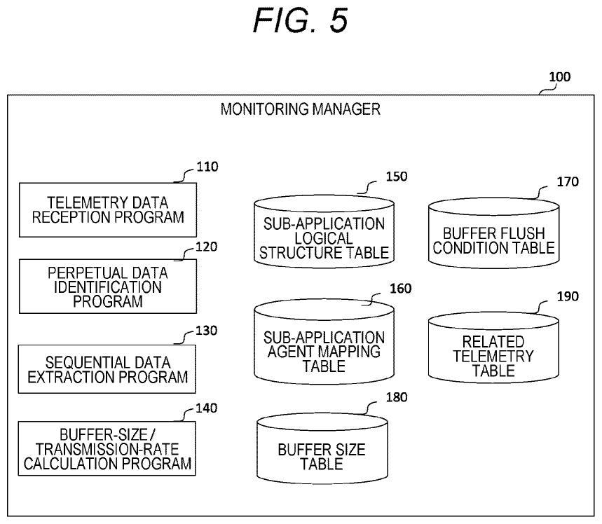

FIG. 5 is a block diagram of the monitoring manager.

The monitoring manager 100 is a computer including a processor and a memory (not illustrated), and can be also referred to as a telemetry data collection device. As illustrated in FIG. 5, the monitoring manager 100 includes a telemetry data reception program 110, a perpetual data identification program 120, a sequential data extraction program 130, and a buffer-size/transmission-rate calculation program 140 such that these programs are executable. Further, the monitoring manager 100 stores a sub-application logical structure table 150, a sub-application agent mapping table 160, a buffer flush condition table 170, a buffer size table 180, and a related telemetry table 190.

It can be considered that a telemetry data reception unit, a perpetual data identification unit, a sequential data extraction unit, and a buffer-size/transmission-rate calculation unit are logically structured in the telemetry collection device, through execution of the telemetry data reception program 110, the perpetual data identification program 120, the sequential data extraction program 130, and the buffer-size/transmission-rate calculation program 140, respectively, by the processor. Processes realized by execution of the respective programs by the processor using the respective tables will be described later in detail.

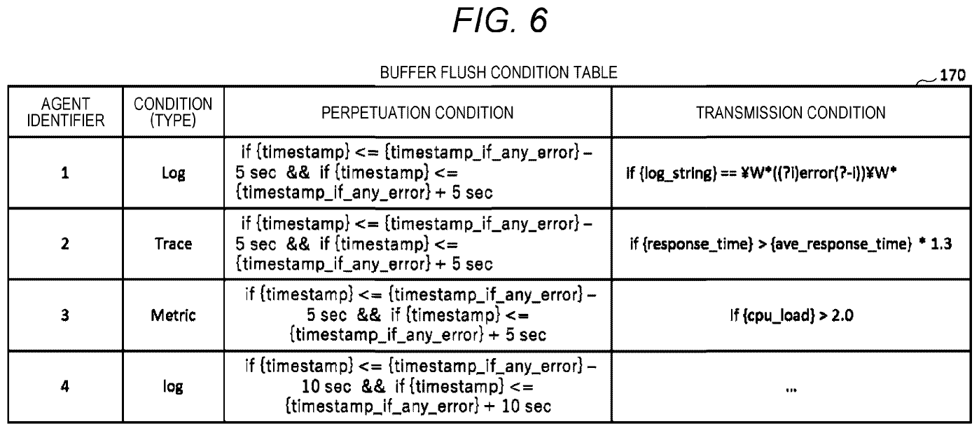

FIG. 6 is a diagram illustrating an example of the buffer flush condition table. The buffer flush condition table 170 is a table defining buffer flush conditions, and perpetuation conditions and transmission conditions in cases where the respective buffer flush conditions are satisfied.

Referring to FIG. 6, in the buffer flush condition table 170, agent identifiers, conditions, perpetuation conditions, and transmission conditions are registered in association with each other. Each agent identifier is an identifier for identifying a monitoring agent container 200. The aforementioned conditions define buffer flush conditions for the respective types of data.

If telemetry data of the type in a certain entry in the buffer flush condition table 170 has been received from the monitoring agent container 200 corresponding to the agent identifier in this entry, it is determined that buffer flushing is to be performed. Further, the perpetuation condition and the transmission condition in this entry are used for buffer flushing.

Taking the first entry as an example, if telemetry data of a data type “log data” is received from the monitoring agent container 200 with an agent identifier of “1”, it is determined that buffer flushing is to be performed. Further, in this case, the perpetuation condition is “if {timestamp}<={timestamp_if_any_error}−5 sec & & if {timestamp}<={timestamp_if_any_error}+5 sec”. As in this example, in the perpetuation condition, the data range may be specified by a time range of the time of acquisition of the telemetry data (namely, a timestamp of the telemetry data). Further, the transmission condition is “if {log string}==\W*((? i) error (?-i))\W*”. The transmission condition may be specified by a telemetry identifier identifying the telemetry data and/or a time range of the time of acquisition of the telemetry data.

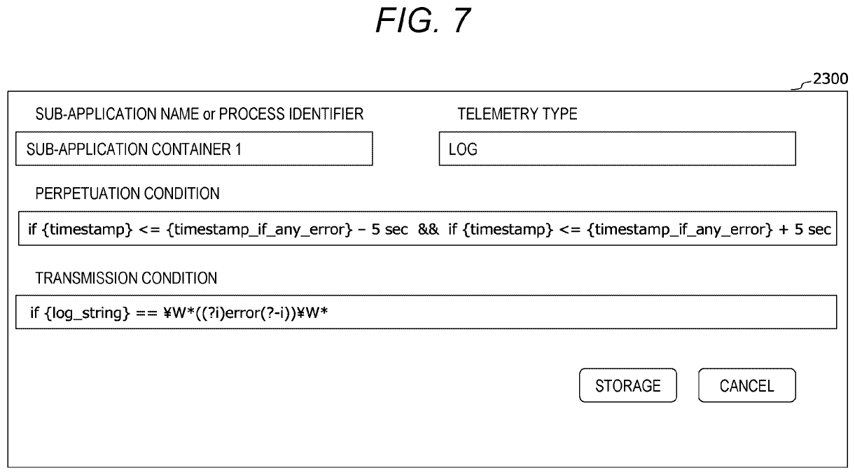

FIG. 7 is a view illustrating an example of a screen for setting a buffer flush condition.

Referring to FIG. 7, a buffer flush condition setting screen 2300 is a graphical user interface (GUI) screen for receiving inputs from a user. In the buffer flush condition setting screen 2300, there are placed respective text boxes for “sub application name or process identifier”, “telemetry type”, “perpetuation condition”, and “transmission condition”, and respective buttons for “save” and “cancel”.

By inputting a sub application name or a process identifier in the text box for “sub application name or process identifier”, it is possible to designate a sub application container 600. In the buffer flush condition table 170, the agent identifier of the monitoring agent container 200 disposed in the same host 800 as the host on which the designated sub application container 600 is disposed is set.

By inputting a type of telemetry data in the text box for “telemetry type”, it is possible to designate a condition for determining that buffer flush is necessary. In the buffer flush condition table 170, the inputted type of telemetry data is set as a condition.

In the text box for “perpetuation condition”, a perpetuation condition can be inputted. The inputted perpetuation condition is set in the buffer flush condition table 170.

In the text box for “transmission condition”, a transmission condition can be inputted. The inputted transmission condition is set in the buffer flush condition table 170.

The “save” button is a button for confirming the buffer flush condition inputted in the text boxes. If the “save” button is pressed, a buffer flush condition is generated according to the text information inputted in the respective text boxes, and the generated buffer flush condition is set in the buffer flush condition table 170.

The “cancel” button is a button for canceling the generation of the buffer flush condition by the text inputted in the text boxes. If the “cancel” button is pressed, the information inputted in the text boxes is cleared, and the buffer flush condition is not generated.

As illustrated in this example, the perpetuation condition and/or the transmission condition may be set by an arithmetic expression or a regular expression. Since the perpetuation condition and/or the transmission condition is specified through an arithmetic expression or a regular expression, it is possible to appropriately collect effective telemetry data.

Also, when text has been inputted in the text box for “condition” and the text box for “perpetuation condition” in the buffer flush condition setting screen 2300, if there is a buffer flush condition including the same condition and perpetuation condition thereas, among the buffer flush conditions having been ever set, the text set as the transmission condition in this buffer flush condition may be displayed as a recommended text input, in the text box for “transmission condition”.

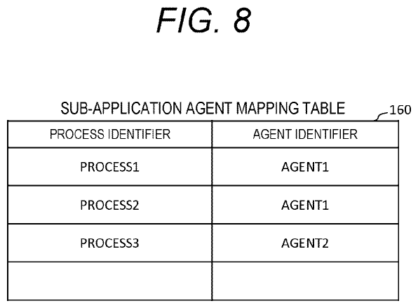

FIG. 8 is a diagram illustrating an example of a sub-application agent mapping table. The sub-application agent mapping table 160 is a table that associates each sub-application container 600 with the monitoring agent container 200 disposed on the same host 800 as the host on which the sub-application container is disposed.

Referring to FIG. 8, process identifiers and agent identifiers are registered in association with each other, in the sub-application agent mapping table 160. Each process identifier is an identifier for identifying the process of a sub application. Each agent identifier is an identifier for identifying a monitoring agent container 200.

In each entry of the sub-application agent mapping table 160, the sub-application container 600 of the process corresponding to the process identifier, and the monitoring agent container 200 corresponding to the agent identifier are disposed on the same host 800.

For example, in the first entry, it is indicated that a sub-application container 600 of a process with a process identifier of “PROCESS 1”, and a monitoring agent container 200 with an agent identifier of “AGENT1” are disposed on the same host 800.

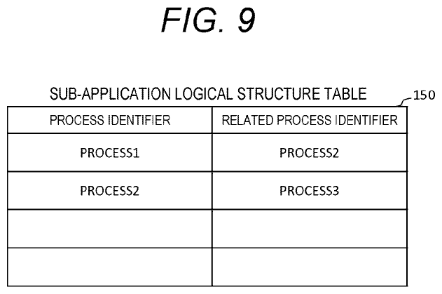

FIG. 9 is a diagram illustrating an example of a sub-application logical structure table. The sub-application logical structure table 150 is a table that associates sub applications with sub applications related thereto. The term “related thereto” means having a dependence relationship therewith, for example. The sub-application logical structure table 150 is used for identifying sub applications in which telemetry data is to be perpetuated and from which telemetry data is to be additionally collected.

Referring to FIG. 9, process identifiers and relating process identifiers are registered in association with each other, in the sub-application logical structure table 150. The process identifiers and the relating process identifiers are both identifiers for identifying the processes of sub-application containers 600.

It is indicated that, in each entry of the sub-application logical structure table 150, the sub application of the process corresponding to the process identifier is related to the sub application of the process corresponding to the related process identifier.

For example, in the first entry, it is indicated that a sub-application of a process with a process identifier of “PROCESS1” is related to a sub-application of a process with a process identifier of “PROCESS2”.

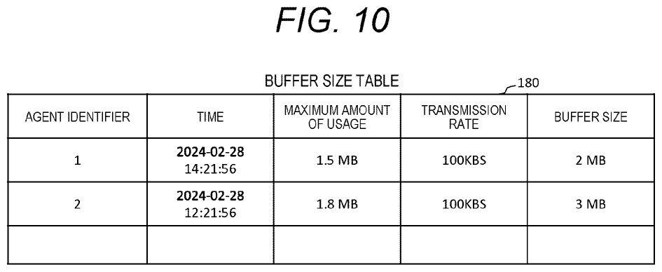

FIG. 10 is a diagram illustrating an example of a buffer size table. A buffer size table 180 is a table which records a buffer size and a usage state of the sub-application ring buffers 210 included in each monitoring agent container 200.

Referring to FIG. 10, in the buffer size table 180, there are recorded agent identifiers, times, maximum amounts of usage, transmission rates, and buffer sizes, in association with each other. Each agent identifier is an identifier for identifying a monitoring agent container 200. Each time indicates the time of confirmation of the maximum amount of usage in the entry. Each maximum amount of usage indicates a maximum value of the amount of usage of the sub-application ring buffers 210, which was confirmed at the time indicated in the field of time. Each transmission rate is a data rate at which the monitoring agent container 200 transmits telemetry data in the sub-application ring buffers 210. Each buffer size indicates the capacity of telemetry data that can be held in the sub-application ring buffers 210.

In each entry of the buffer size table 180, there is set the maximum amount of usage of the monitoring agent container 200 corresponding to the agent identifier, which was confirmed at the time indicated in the field of time, and, further, there are set the transmission rate and the buffer size of this monitoring agent container 200, and the values thereof are updated as appropriate.

For example, in the first entry, it is indicated that the maximum amount of usage of the monitoring agent container 200 with an agent identifier of “1” is “1.5 Mbytes”, which was confirmed at the time “2024-02-28 14:21:56”, and the transmission rate and the buffer size of the same the monitoring agent container 200 are “100 KBS” and “2 MB”, respectively.

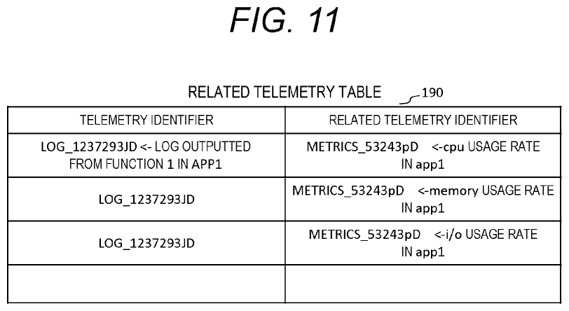

FIG. 11 is a diagram illustrating an example of a related telemetry table. The related telemetry table 190 is a table that associates telemetry data and telemetry data related thereto with each other. The term “telemetry data and telemetry data related thereto” means telemetry data and telemetry data which indicate matters correlated to each other. The related telemetry table 190 is used for identifying telemetry data to be additionally transmitted.

Referring to FIG. 11, telemetry identifiers and related telemetry identifiers are registered in association with each other, in the related telemetry table 190. The telemetry identifiers and the related telemetry identifiers are both identifiers for identifying telemetry data.

It is illustrated that, in each entry of the related telemetry table 190, telemetry data corresponding to the telemetry identifier is related to telemetry data corresponding to the related telemetry identifier.

For example, in the first entry, it is illustrated that telemetry data with a telemetry identifier of “LOG_1237293JD” is related to telemetry data with a telemetry identifier of “METRICS 53243pD”.

Here, the telemetry data with the telemetry identifier “LOG_1237293 JD” is log data outputted from a function 1 of a sub application “APP1”. Further, the telemetry data with the telemetry identifier “METRICS_53243pD” is metric data “cpu usage rate” in a sub application “app1”.

Therefore, the first entry means that log data outputted from the function 1 of the sub application “APP1” is related to metric data “cpu usage rate” in the sub application “app1”.

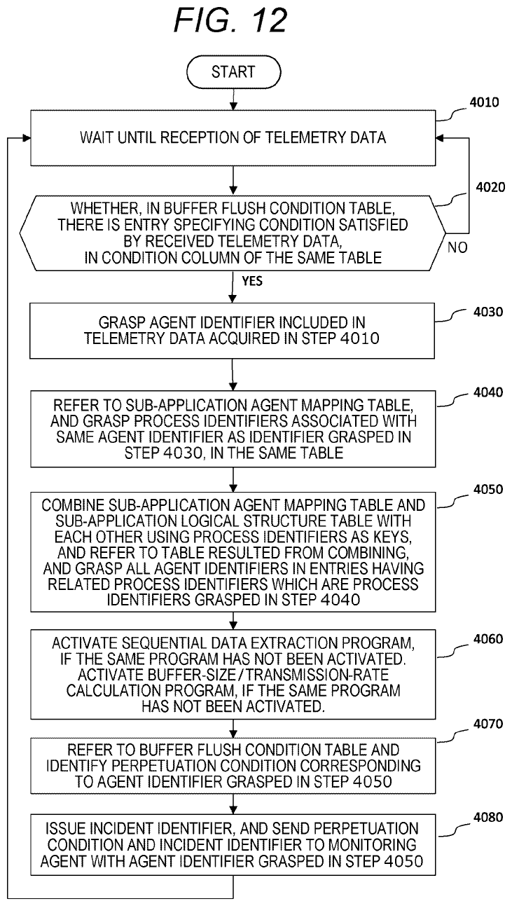

FIG. 12 is a flowchart of a perpetual data identification process. The perpetual data identification process is a process realized through execution of the perpetual data identification program 120 in the monitoring manager 100 by the processor. The perpetual data identification process is activated at the time of activation of the target system and the telemetry data collection system. The perpetual data identification process is process, as follows. That is, when it is necessary to transmit telemetry data stored in a sub-application ring buffer 210 in a monitoring agent container 200 to the monitoring manager 100, the perpetual data identification process identifies a data range to be perpetuated and requests the monitoring agent container 200 to perpetuate the data region.

Referring to FIG. 12, the monitoring manager 100 waits until it receives telemetry data (step 4010). The telemetry data is extracted from the trace data store 300, the metric data store 400, and the log data store 500 by processing of the telemetry data reception program 110 and, therefore, the extracted telemetry data may be monitored.

If telemetry data is received, the monitoring manager 100 determines whether or not there is an entry having a condition satisfied by the received telemetry data, in the buffer flush condition table 170 (step 4020). If there is no entry having a condition satisfied by the received telemetry data, in the buffer flush condition table 170, the process returns to the step 4010.

If there is an entry having a condition satisfied by the received telemetry data, in the buffer flush condition table 170, the monitoring manager 100 grasps the agent identifier included in the telemetry data acquired in the step 4010 (step 4030).

Subsequently, the monitoring manager 100 refers to the sub-application agent mapping table 160, and grasps the process identifiers in all the entries having the same agent identifier as that grasped in the step 4030, in the same table (step 4040).

Subsequently, the monitoring manager 100 combines the sub-application agent mapping table 160 and the sub-application logical structure table 150 with each other using the process identifiers as keys. Further, the monitoring manager 100 refers to the table resulted from the combining, and grasps the agent identifiers in all the entries having related process identifiers which are the process identifiers grasped in the step 4040 (step 4050).

Subsequently, if the sequential data extraction program 130 has not been activated, the monitoring manager 100 activates the same program. Further, if the buffer-size/transmission-rate calculation program 140 has not been activated, the monitoring manager activates the same program (step 4060).

Subsequently, the monitoring manager 100 refers to the buffer flush condition table 170 and identifies the perpetuation condition corresponding to each agent identifier grasped in the step 4050 (step 4070).

Subsequently, the monitoring manager 100 issues an incident identifier, and makes a request for perpetuation to the monitoring agent container 200 with each agent identifier grasped in the step 4050 by sending the perpetuation condition and the incident identifier thereto (step 4080). Here, the term “issuing an incident identifier” means giving a new incident identifier to a new incident, indicating that the new incident has occurred.

Then, the monitoring manager 100 returns to the step 4010 and repeats the processing.

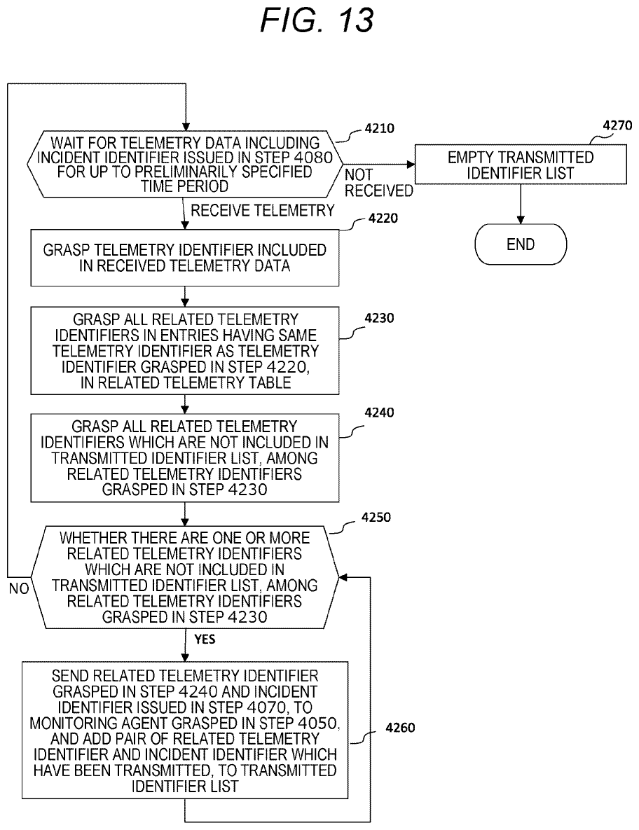

FIG. 13 is a flowchart of a sequential data extraction process. The sequential data extraction process is a process realized through execution of the sequential data extraction program 130 in the monitoring manager 100 by the processor. The sequential data extraction process is activated by the process in the aforementioned step 4060. The sequential data extraction process is a process for sequentially selecting necessary data from data perpetuated in a sub-application ring buffer 210 and for performing buffer flushing thereon.

Referring to FIG. 13, the monitoring manager 100 waits for reception of telemetry data including the incident identifier issued in the step 4080 for up to a predetermined time period as a limit (step 4210).

If the telemetry data is received within the predetermined time period, the monitoring manager 100 grasps the telemetry identifier included in the received telemetry data (step 4220).

Subsequently, the monitoring manager 100 refers to the related telemetry table 190 and grasps the related telemetry identifiers in all the entries having the same telemetry identifier as the telemetry identifier grasped in the step 4220 (step 4230).

Subsequently, the monitoring manager 100 grasps all the related telemetry identifiers which are not included in a transmitted identifier list, among the related telemetry identifiers grasped in the step 4230 (step 4240). The transmitted identifier list is list information for recording the telemetry identifiers of telemetry of telemetry data having been already transmitted. In an initial state, the transmitted identifier list is empty, and the number of telemetry identifiers increases therein as the process proceeds.

Subsequently, the monitoring manager 100 determines whether or not there are one or more related telemetry identifiers which are not included in the transmitted identifier list, among the related telemetry identifiers grasped in the step 4230 (step 4250). If there is no related telemetry identifier that is not included in the transmitted identifier list, among the related telemetry identifiers grasped in the step 4230, the process returns to the step 4210.

If there is at least one related telemetry identifier that is not included in the transmitted identifier list, among the related telemetry identifiers grasped in the step 4230, the monitoring manager 100 subsequently sends the related telemetry identifier grasped in the step 4240 and the incident identifier issued in the step 4070, to the monitoring agent container 200 grasped in the step 4050 (step 4260). Then, the monitoring manager 100 adds the pair of the related telemetry identifier and the incident identifier which have been transmitted, to the transmitted identifier list.

The related telemetry identifier and the incident identifier which are sent by the monitoring manager 100 are information indicating telemetry data (additional transmission telemetry data) to be additionally transmitted. On receiving the related telemetry identifier and the incident identifier, the monitoring agent container 200 transmits the telemetry data perpetuated in the sub-application ring buffer 210, to the monitoring manager 100, in accordance with the information.

After the step 4260, the monitoring manager 100 returns to the step 4250.

In the step 4210, if the telemetry data is not received within the predetermined time period, the monitoring manager 100 determines that necessary telemetry data has been collected, and the monitoring manager 100 clears the transmitted identifier list to empty it, and ends the process (step 4270).

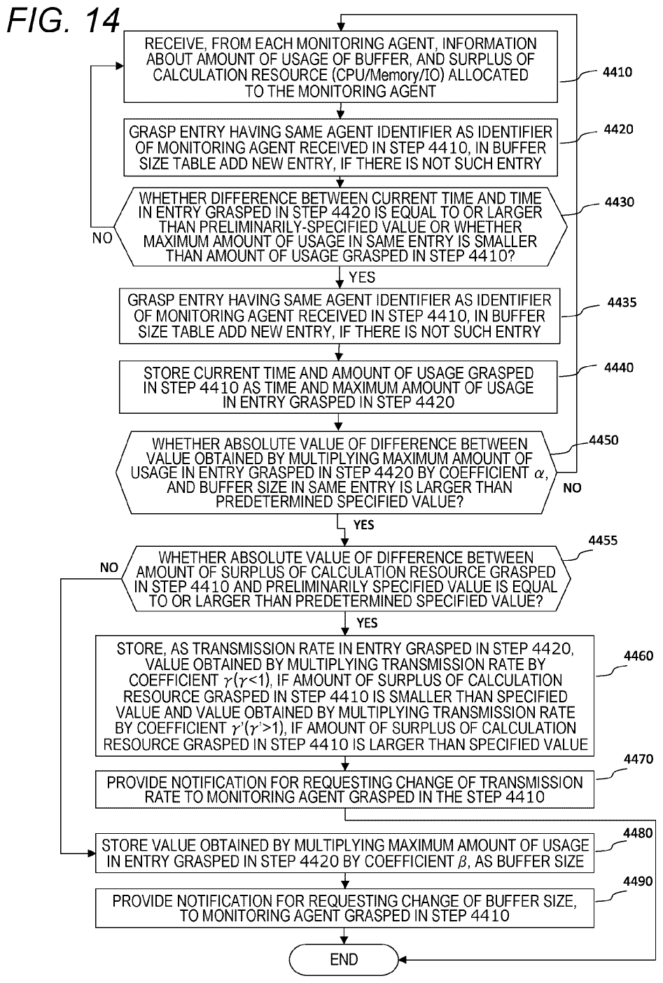

FIG. 14 is a flowchart of a buffer-size/transmission-rate calculation process. The buffer-size/transmission-rate calculation process is a process realized through execution of the buffer-size/transmission-rate calculation program 140 in the monitoring manager 100 by the processor. The buffer-size/transmission-rate calculation process is activated by the process in the aforementioned step 4060. The buffer-size/transmission-rate calculation process is a process for appropriately controlling the buffer size and the transmission rate of the sub-application ring buffers 210 in the monitoring agent containers 200.

Referring to FIG. 14, the monitoring manager 100 receives, from each monitoring agent container 200, information indicating the amount of usage of the sub-application ring buffers 210, and the surplus of the calculation resources (CPU/Memory/IO) allocated to the monitoring agent container 200 (step 4410).

Subsequently, the monitoring manager 100 grasps an entry having the same agent identifier as the agent identifier of the monitoring agent container 200 received in the step 4410, in the buffer size table 180 (step 4420). If there is not such an entry, the monitoring manager 100 adds a new entry thereto.

Subsequently, the monitoring manager 100 determines whether the difference between the current time and the time in the entry grasped in the step 4420 is equal to or larger than a preliminarily-specified value or whether the maximum amount of usage in the same entry is smaller than the amount of usage grasped in the step 4410 (step 4430).

If the difference between the current time and the time in the entry grasped in the step 4420 is not equal to or larger than the preliminarily-specified value, and the maximum amount of usage in the same entry is not smaller than the amount of usage grasped in the step 4410, the process returns to the step 4410.

On the other hand, if the difference between the current time and the time in the entry grasped in the step 4420 is equal to or larger than the preliminarily-specified value, or if the maximum amount of usage in the same entry is smaller than the amount of usage grasped in the step 4410, the monitoring manager 100 grasps the entry having the same agent identifier as the agent identifier of the monitoring agent container 200 received in the step 4410, in the buffer size table 180 (step 4435). If there is not such an entry, the monitoring manager 100 adds a new entry thereto.

Subsequently, the monitoring manager 100 stores the current time and the amount of usage grasped in the step 4410 as the time and the maximum amount of usage in the entry grasped in the step 4420 (step 4440).

Subsequently, the monitoring manager 100 determines whether or not the absolute value of the difference between the value obtained by multiplying the maximum amount of usage in the entry grasped in the step 4420 by a coefficient, and the buffer size in the same entry is larger than a predetermined specified value (step 4450). The coefficient α is a value by which the maximum amount of usage is multiplied, in order to give a margin to the buffer size. The coefficient α is a value of 1 or more, for example.

If the absolute value of the difference between the value obtained by multiplying the maximum amount of usage in the entry grasped in the step 4420 by the coefficient α, and the buffer size in the same entry is not larger than the predetermined specified value, the process returns to the step 4410.

On the other hand, if the absolute value of the difference between the value obtained by multiplying the maximum amount of usage in the entry grasped in the step 4420 by the coefficient α, and the buffer size in the same entry is larger than the predetermined specified value, the monitoring manager 100 determines whether or not the absolute value of the difference between the amount of the surplus of the calculation resources grasped in the step 4410 and a preliminarily specified value is equal to or larger than a predetermined specified value (step 4455).

If the absolute value of the difference between the amount of the surplus of the calculation resources grasped in the step 4410 and the preliminarily specified value is equal to or larger than the predetermined specified value, the monitoring manager 100 stores a value as follows, as the transmission rate in the entry grasped in the step 4420. That is, if the amount of the surplus of the calculation resources grasped in the step 4410 is smaller than a specified value, the monitoring manager 100 stores, the value obtained by multiplying the transmission rate by a coefficient γ (γ<1). If the amount of the surplus of the calculation resources grasped in the step 4410 is larger than the specified value, the monitoring manager 100 stores, the value obtained by multiplying the transmission rate by a coefficient γ′(γ′>1) (step 4460).

Subsequently, the monitoring manager 100 transmits a notification for requesting a change of the transmission rate to the monitoring agent container 200 grasped in the step 4410 (step 4470), and ends the process.

On the other hand, in the step 4455, if the absolute value of the difference between the amount of the surplus of the calculation resources grasped in the step 4410 and the preliminarily specified value is not equal to or larger than the predetermined specified value, the monitoring manager 100 stores the value obtained by multiplying the maximum amount of usage in the entry grasped in the step 4420 by a coefficient β, as the buffer size of the sub-application ring buffers (step 4480).

Subsequently, the monitoring manager 100 provides a notification for requesting a change of the buffer size, to the monitoring agent container 200 grasped in the step 4410 (step 4490), and ends the process.

The aforementioned embodiment is merely an example for describing the present invention, and is not intended to limit the scope of the present invention to the embodiment. Those skilled in the art can implement the present invention in other various aspects, without departing from the scope of the present invention.

Further, the aforementioned embodiment includes the following matters. However, matters included in the aforementioned embodiment are not limited to the following matters.

### (Matter 1)

A telemetry data collection system for collecting telemetry data in an application constituted by a plurality of sub applications, the telemetry data collection system including: monitoring agents adapted to acquire telemetry data from processes of the sub applications; and a monitoring manager adapted to receive telemetry data from the monitoring agents, wherein the monitoring agents record the acquired telemetry data in a buffer and transmit telemetry data satisfying a predetermined condition, out of the acquired telemetry data, to the monitoring manager, and the monitoring manager identifies a perpetuation condition indicating a perpetuation monitoring agent as a monitoring agent to perpetuate telemetry data recorded in the buffer, and a perpetual data range indicating a data range to be perpetuated out of the telemetry data recorded in the buffer, and a transmission condition indicating an additional transmission monitoring agent as a monitoring agent from which telemetry data is to be additionally collected, and additional transmission telemetry data as telemetry data to be additionally collected, based on the telemetry data received from the monitoring agents, the monitoring manager notifies the perpetuation monitoring agent of the perpetuation condition, the perpetuation monitoring agent perpetuates the perpetual data range according to the notified perpetuation condition, the monitoring manager notifies the additional transmission monitoring agent of the transmission condition, and the additional transmission monitoring agent transmits the additional transmission telemetry data in the buffer to the monitoring manager according to the notified transmission condition. Consequently, the monitoring manager controls perpetuation and transmission of telemetry data buffered in the monitoring agents, based on telemetry data received from the monitoring agents. This enables collecting effective telemetry data from the distributed system.

### (Matter 2)

In the telemetry data collection system according to Matter 1, on receiving the telemetry data transmitted from the additional transmission monitoring agent according to the transmission condition, the monitoring manager identifies, again, a new transmission condition indicating a new additional transmission monitoring agent and additional transmission telemetry data, based on the received telemetry data, and the monitoring manager notifies the new additional transmission monitoring agent of the new transmission condition. Consequently, the monitoring manager recursively repeats the process for controlling further transmission of telemetry data in the monitoring agents based on the telemetry data received from the monitoring agents. This enables collecting effective telemetry data.

### (Matter 3)

In the telemetry data collection system according to Matter 1, the monitoring manager designates the data range in the perpetuation condition by a time range of a time of acquisition of telemetry data. Consequently, the data range is specified by the time range of the time stamp, which enables easily collecting telemetry data in an appropriate data range.

### (Matter 4)

In the telemetry data collection system according to Matter 1, the monitoring manager designates the transmission condition by a telemetry identifier for identifying the telemetry data and/or a time range of a time of acquisition of the telemetry data. Consequently, the transmission condition is specified by the identifier for identifying the telemetry data and/or the time range of the time stamp, which enables easily collecting appropriate telemetry data.

### (Matter 5)

In the telemetry data collection system according to Matter 1, when a state where telemetry data according to the transmission condition is not received has continued for a predetermined threshold time period, the monitoring manager requests the perpetuation monitoring agent to release perpetuation, and the perpetuation monitoring agent releases the perpetuation of the perpetual data range. Consequently, the telemetry data in the buffer is perpetuated until the completion of collection of telemetry data, which enables reliably collecting effective telemetry data.

### (Matter 6)

In the telemetry data collection system according to Matter 1, the monitoring manager acquires information about an amount of usage of the buffer and information about a surplus of a calculation resource from the monitoring agent, controls a buffer size in the monitoring agent based on the amount of usage of the buffer, and controls a transmission rate at which telemetry data in the monitoring agent is transmitted based on the surplus of the calculation resource. This enables appropriately controlling the buffer size and the transmission rate of the monitoring agent, thereby effectively collecting telemetry data.

### (Matter 7)

In the telemetry data collection system according to Matter 1, the monitoring manager sets the transmission condition by an arithmetic expression or a regular expression for determining a target application, and whether telemetry data is telemetry data to be transmitted. Consequently, the transmission condition is specified by the arithmetic expression or the regular expression, which enables appropriately collecting effective telemetry data.

### (Matter 8)

In the telemetry data collection system according to Matter 7, the monitoring manager provides a graphical user interface for receiving the transmission condition through a text input in a screen. This enables the user to easily set the transmission condition through the GUI screen.

### (Matter 9)

In the telemetry data collection system according to Matter 8, the monitoring manager receives, on the screen, a condition for determining that buffer flushing is necessary, the perpetuation condition, and the transmission condition through a text input, and when the condition and the perpetuation condition have been inputted, the monitoring manager displays a transmission condition set in association with this condition and this perpetuation condition in a buffer flush condition having been already set, as a recommended text input. This enables the user to easily set the transmission condition through the recommendation on the GUI screen.

### REFERENCE SIGNS LIST

100 monitoring manager
110 telemetry data reception program
120 perpetual data identification program
130 sequential data extraction program
140 transmission-rate calculation program
150 sub-application logical structure table
160 agent mapping table
170 buffer flush condition table
180 buffer size table
190 related telemetry table
200 monitoring agent container
210 sub-application ring buffer
300 trace data store
400 metric data store
500 log data store
600 sub-application container
700 container runtime
800 host
2300 buffer flush condition setting screen

1. A telemetry data collection system for collecting telemetry data in an application comprising a plurality of sub applications, the telemetry data collection system comprising:
monitoring agents adapted to acquire telemetry data from a process of the sub applications; and
a monitoring manager adapted to receive telemetry data from the monitoring agents;
wherein the monitoring agents record the acquired telemetry data in a buffer and transmit telemetry data satisfying a predetermined condition, out of the acquired telemetry data, to the monitoring manager,
the monitoring manager identifies a perpetuation condition indicating a perpetuation monitoring agent as a monitoring agent to perpetuate telemetry data recorded in the buffer, and a perpetual data range indicating a data range to be perpetuated out of the telemetry data recorded in the buffer, and a transmission condition indicating an additional transmission monitoring agent as a monitoring agent from which telemetry data is to be additionally collected, and additional transmission telemetry data as telemetry data to be additionally collected, based on the telemetry data received from the monitoring agents,
the monitoring manager notifies the perpetuation monitoring agent of the perpetuation condition,
the perpetuation monitoring agent perpetuates the perpetual data range according to the notified perpetuation condition,
the monitoring manager notifies the additional transmission monitoring agent of the transmission condition, and
the additional transmission monitoring agent transmits the additional transmission telemetry data in the buffer to the monitoring manager according to the notified transmission condition.

2. The telemetry data collection system according to claim 1, wherein
on receiving the telemetry data transmitted from the additional transmission monitoring agent according to the transmission condition, the monitoring manager identifies, again, a new transmission condition indicating a new additional transmission monitoring agent and additional transmission telemetry data, based on the received telemetry data, and
the monitoring manager notifies the new additional transmission monitoring agent of the new transmission condition.

3. The telemetry data collection system according to claim 1, wherein the monitoring manager designates the data range in the perpetuation condition by a time range of a time of acquisition of telemetry data.

4. The telemetry data collection system according to claim 1, wherein the monitoring manager designates the transmission condition by a telemetry identifier for identifying the telemetry data and/or a time range of a time of acquisition of the telemetry data.

5. The telemetry data collection system according to claim 1, wherein
when a state where telemetry data according to the transmission condition is not received has continued for a predetermined threshold time period, the monitoring manager requests the perpetuation monitoring agent to release perpetuation, and
the perpetuation monitoring agent releases the perpetuation of the perpetual data range.

6. The telemetry data collection system according to claim 1, wherein
the monitoring manager acquires information about an amount of usage of the buffer, and information about a surplus of a calculation resource, from the monitoring agent,
the monitoring manager controls a buffer size in the monitoring agent, based on the amount of usage of the buffer, and
the monitoring manager controls a transmission rate at which telemetry data in the monitoring agent is transmitted, based on the surplus of the calculation resource.

7. The telemetry data collection system according to claim 1, wherein
the monitoring manager sets the transmission condition by an arithmetic expression or a regular expression for determining a target application, and whether telemetry data is telemetry data to be transmitted.

8. The telemetry data collection system according to claim 7, wherein
the monitoring manager provides a graphical user interface for receiving the transmission condition through a text input in a screen.

9. The telemetry data collection system according to claim 8, wherein
the monitoring manager receives, on the screen, a condition for determining that buffer flushing is necessary, the perpetuation condition, and the transmission condition through a text input, and when the condition and the perpetuation condition have been inputted, the monitoring manager displays a transmission condition set in association with this condition and this perpetuation condition in a buffer flush condition having been already set, as a recommended text input.

10. A telemetry data collection device for collecting telemetry data from monitoring agents, in an application comprising a plurality of sub applications, the monitoring agents being adapted to acquire telemetry data from a process of the sub applications, record the acquired telemetry data in a buffer and transmit telemetry data satisfying a predetermined condition, out of the acquired telemetry data, the telemetry data collection device comprising:
a perpetual data identification unit adapted to identify a perpetuation condition indicating a perpetuation monitoring agent as a monitoring agent to perpetuate telemetry data recorded in the buffer, and a perpetual data range indicating a data range to be perpetuated out of the telemetry data recorded in the buffer, and a transmission condition indicating an additional transmission monitoring agent as a monitoring agent from which telemetry data is to be additionally collected, and additional transmission telemetry data as telemetry data to be additionally collected, based on the telemetry data received from the monitoring agents, and adapted to notify the perpetuation monitoring agent of the perpetuation condition, and
a sequential data extraction unit adapted to notify the additional transmission monitoring agent of the transmission condition, and to receive the additional transmission telemetry data in the buffer from the additional transmission monitoring agent according to the transmission condition.

11. A telemetry data collection method for collecting telemetry data in an application comprising a plurality of sub applications, through monitoring agents adapted to acquire telemetry data from a process of the sub applications, and a monitoring manager adapted to receive telemetry data from the monitoring agents,
wherein the monitoring agents record the acquired telemetry data in a buffer and transmit telemetry data satisfying a predetermined condition, out of the acquired telemetry data, to the monitoring manager,
the monitoring manager identifies a perpetuation condition indicating a perpetuation monitoring agent as a monitoring agent to perpetuate telemetry data recorded in the buffer, and a perpetual data range indicating a data range to be perpetuated out of the telemetry data recorded in the buffer, and a transmission condition indicating an additional transmission monitoring agent as a monitoring agent from which telemetry data is to be additionally collected, and additional transmission telemetry data as telemetry data to be additionally collected, based on the telemetry data received from the monitoring agents,
the monitoring manager notifies the perpetuation monitoring agent of the perpetuation condition,
the perpetuation monitoring agent perpetuates the perpetual data range according to the notified perpetuation condition,
the monitoring manager notifies the additional transmission monitoring agent of the transmission condition, and
the additional transmission monitoring agent transmits the additional transmission telemetry data in the buffer to the monitoring manager according to the notified transmission condition.
